(19) United States
(12) Patent Application Publication
(10) Pub. No.: US 2010/0212079 A1
(43) Pub. Date: Aug. 26, 2010

(54) Universal flush valve kit and method of using

(76) Inventors: Chris W. Jeffers, Hebron, CT (US); Matthew J. Siena, Portland, CT (US)

Correspondence Address: ALIX YALE & RISTAS LLP, 750 MAIN STREET, SUITE 1400, HARTFORD, CT, 06103, US

(21) Appl. No.: 12/380,303

(22) Filed: Feb. 26, 2009

(51) Int. Cl. E03D 1/34; B23P 17/04

(52) U.S. Cl. 4/378; 29/428

(57) ABSTRACT

An adapter cup for use in a multi-piece valve assembly, a universal flush valve assembly kit and a method of installing in a flush tank with a discharge hole. The kit has a first adapter cup, an additional adapter cup and a main body valve fitting. The adapter cups have substantially identical upper rims that are configured for attachment to the main body valve fitting. Each adapter cup has a lower cylindrical portion with a different outer diameter than that of the other adapter cup. The lower portion of one of the adapter cups is inserted into a discharge hole of like or substantially similar diameter. The main body fitting with an inlet and outlet is attached to the rim of the inserted adapter cup. A flapper is swingable relative to the main body fitting from a closed position abutting the outlet to an open position raised from the inlet. A single flush tank valve assembly can be installed into toilet tanks with different sized discharge holes.

### BACKGROUND OF THE DISCLOSURE

The present disclosure relates to flush tanks, and more particularly, to the valve assembly associated with toilet bowl flush tanks.

Both consumer and institutional toilets can be ordered in a wide variety of sizes, styles, and colors. Regardless of this wide variety of available options, most toilets are operated by a valve assembly installed at the discharge hole of the flush tank. However, discharge holes can vary in size, requiring different sized valve parts. Traditionally, toilets have utilized tanks with two inch diameter discharge holes. In recent years, toilet manufacturers have introduced “high flow” toilets that increase flushing capabilities by using larger, usually three inch, diameter discharge holes. The varying sizes of discharge holes in toilet tanks create a challenge for repair or installation and a need in the market for valve parts that differ in size and configuration.

### SUMMARY

There is a need for a universal kit with valve assembly parts that are appropriate for installation into flush tanks with different sized discharge holes. The present disclosure is directed to a kit, an adapter cup and a method for installing a valve assembly using the kit components, whereby a single flush tank valve assembly can be installed into toilet tanks with different sized discharge holes.

According to one embodiment of the disclosed device, a cup for use in a multi-piece valve assembly in a flush tank with a discharge hole is provided. The cup has a substantially cylindrical lower portion and an upper rim. The rim has an outer surface and an inner surface that defines a bore. The lower portion has an outer diameter D₂ that corresponds substantially to the diameter of the discharge hole. The rim is configured for fluid tight attachment to another separate piece of the valve assembly. The substantially cylindrical lower portion can be inserted into the discharge hole to create a fluid tight seal therewith.

In another embodiment, a flush valve kit for use in a flush tank having a discharge hole has a first adapter cup, an additional cup and a main body fitting. The first adapter cup defines a first passage with a rim and a lower portion. The lower portion has an outer diameter D₁ and is configured for insertion into a discharge hole. The additional adapter cup defines a second passage and has a rim that is substantially identical to the first cup rim and a lower portion. The additional cup lower portion has an outer diameter D₂. The additional cup lower portion is configured for insertion into a different size discharge hole than the first adapter cup. The main body fitting has an inlet opposite an outlet. The main body fitting is configured to cooperate with either of the substantially identical rims of the first cup and additional cup. The cooperation creates a fluid tight connection between the main body fitting and the respective cup rim proximate the main body fitting outlet. A flapper is configured to swingably attach to the main body fitting. The flapper can swing between a closed position abutting the main body fitting inlet and an open position raised from the inlet. When in the closed position, the flapper creates a fluid tight seal with the inlet.

In another embodiment, the first cup has an axial length and a cylindrical rim with an outer surface and an inner surface that defines an upper bore with a diameter D₁. The inner surface of the rim has a slot adapted to achieve a bayonet fitting. The first cup also has a cylindrical lower portion that defines a lower bore that is in fluid communication with the upper bore. The lower portion has a threaded outer surface and an outer diameter of approximately three inches. An octagonal intermediate portion is positioned axially between the rim and the lower portion and projects radially beyond the respective outer surfaces. The additional cup has a cylindrical rim that is substantially identical to the rim of the first cup. Also present is an additional cylindrical lower portion that defines a second lower bore in fluid communication with the additional upper bore. The additional lower portion also has a threaded outer surface and an outer diameter of approximately two inches. Like on the first cup, an octagonal intermediate portion is positioned axially between the additional cup's upper and lower portions and projects radially beyond their respective outer surfaces. The main body fitting has a cylindrical wall with a first end defining an inlet and a second end defining an outlet. A channel spans between the inlet and outlet. The inlet has a sloped face. The outer surface of the cylindrical wall has a slot proximate the outlet adapted to achieve a bayonet fitting. The bayonet fitting on the cylindrical wall is configured for cooperation with either of the bayonet fittings of the inner surfaces of the substantially identical adapter cup rims. A substantially L-shaped passage extends from a lateral opening in the cylindrical wall and is in fluid communication with the channel. A generally circular flapper is configured to abut the cylindrical wall of the main body fitting at the inlet. When the flapper abuts the cylindrical wall, the outer radial edge of the flapper extends radially beyond the cylindrical wall. The flapper has a projection configured for swingable attachment to the outer surface of the substantially L-shaped passage. Depending on the diameter of the tank's discharge hole, either the first cup lower portion or the additional cup lower portion is inserted into the discharge hole, creating a fluid tight seal therewith. The main body fitting is connected to the rim of the chosen cup via the respective cooperating bayonet fittings. When in a closed position, the flapper abuts the cylindrical wall at the inlet and fluidly seals the tank from the outlet. When a force F is applied on the flapper in the direction away from the inlet, the flapper swings from the closed position to an open position away from the inlet, thus creating fluid communication between the tank and the outlet.

In yet another embodiment, a method of installing a flush tank valve system in a flush tank having a substantially cylindrical discharge hole from a kit is disclosed. The kit comprises a plurality of cups with substantially identical rims and different sized substantially cylindrical lower portions, a main body fitting and a flapper. The substantially identical cup rims are configured to cooperate with the main body fitting to create a fluid tight attachment. The size of the discharge hole is first identified. A cup with a lower portion that corresponds substantially to the size of the discharge hole is chosen from the kit. The lower portion of the chosen cup is then inserted into the discharge hole, creating a fluid tight seal therewith. The main body fitting is attached to and engages with the rim of the chosen cup, thereby cooperating to create a fluid tight connection.

### BRIEF DESCRIPTION OF THE DRAWING

Aspects of the preferred embodiment will be described in reference to the Drawing, where like numerals reflect like elements:

FIG. 1A shows a first adapter cup for use in the embodiments;

FIG. 1B is an elevation view of the first adapter cup of FIG. 1A;

FIG. 2A shows a second adapter cup for use in the embodiments;

FIG. 2B is an elevation view of the second adapter cup of FIG. 2A;

FIG. 3A is an elevation view of a valve main body fitting for use in the embodiments;

FIG. 3B is a longitudinal section view of the valve main body fitting of FIG. 3A;

FIG. 3C is a rear end view of the valve main body fitting of FIGS. 3A and 3B;

FIG. 4 is a vertical section view of a valve main body fitting and an adapter cup engaged with each other and installed in a flush tank with a flapper in a closed position;

FIG. 5 is a vertical section view of a main body fitting and another adapter cup engaged with each other and installed in a flush tank having a smaller diameter discharge hole than the tank of FIG. 4 with a flapper in a closed position;

FIG. 6 depicts the installation of an adapter cup into a discharge hole of a flush tank; and

FIG. 7 is a vertical section view of the engaged main body fitting and adapter cup of FIG. 5 with a flapper in an open position.

### DETAILED DESCRIPTION OF THE PREFERRED EMBODIMENTS

With reference to the drawing wherein like numerals represent like parts throughout the Figures, an adapter cup, a flush valve kit and a method of installing, in a flush tank with a discharge hole (i.e., a traditional toilet bowl tank) are disclosed. Embodiments allow installers to use a single kit or piece to install or replace tank valves in tanks with different discharge hole sizes.

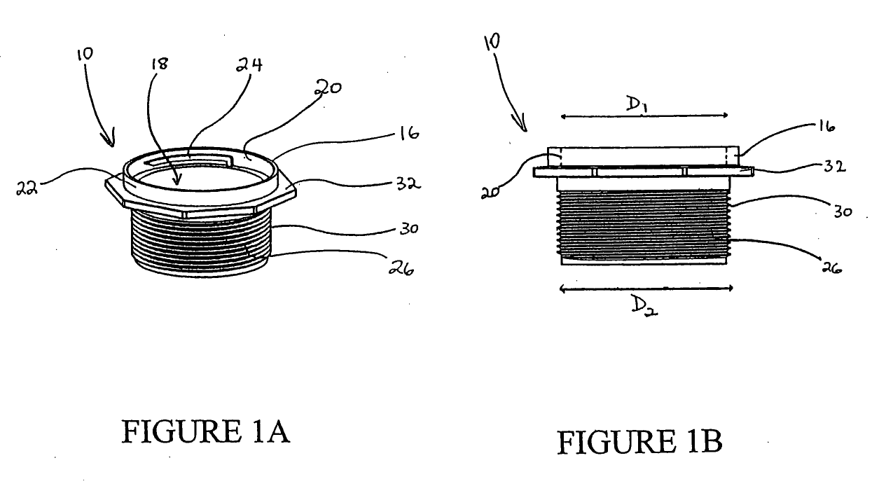

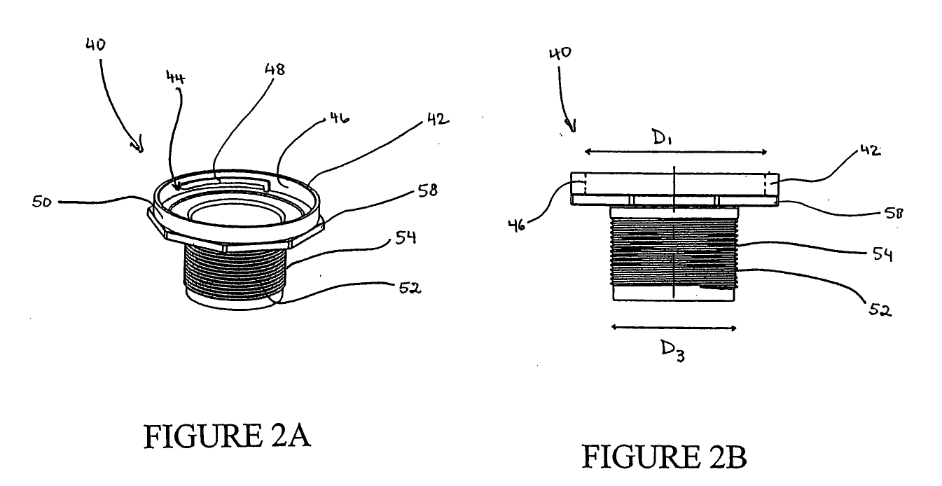

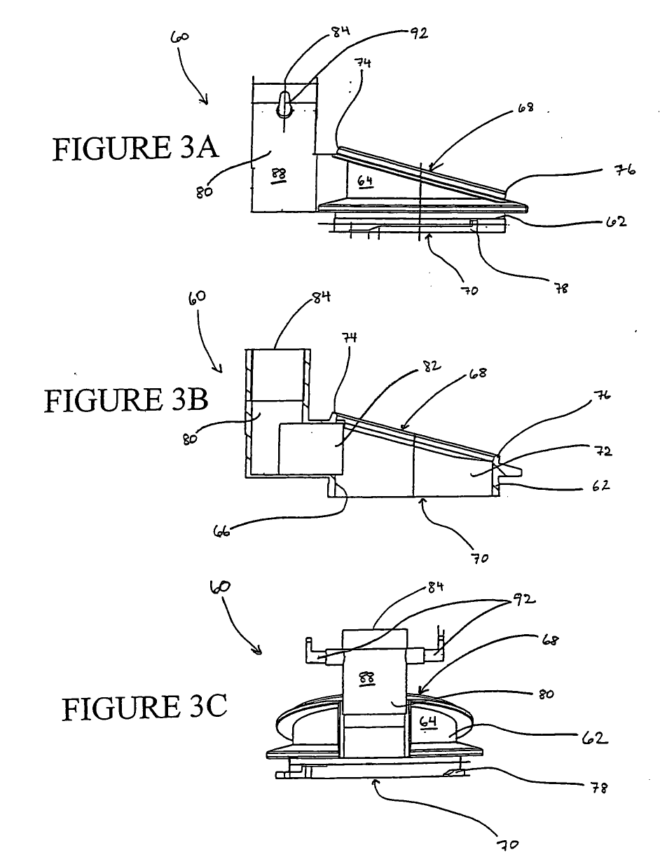

In one embodiment, a single valve kit includes a first adapter cup 10 (an embodiment of which is shown in FIGS. 1A-1B), a second adapter cup 40 (an embodiment of which is shown in FIGS. 2A-2B) and a main body fitting 14 (an embodiment of which is shown in FIGS. 3A-3B).

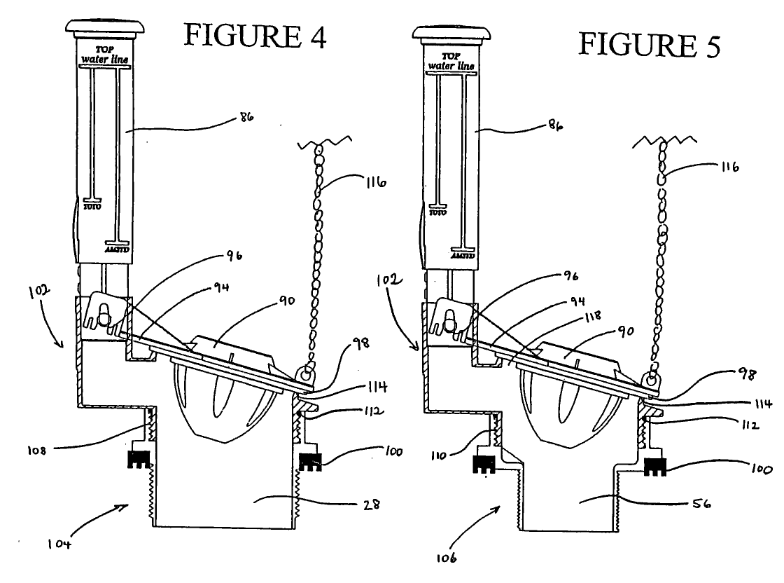

Referring first to FIGS. 1A and 1B, a first adapter cup 10 with an axial length is depicted. The first adapter cup includes a substantially cylindrical rim 16 with an inner surface 20 and an outer surface 22. The inner surface 22 defines an upper bore 18 with a diameter D₁. The inner surface 22 is configured for attachment to another separate piece of a valve assembly. In this embodiment, the inner surface 20 has a slot adapted to achieve a bayonet fitting 24; however the disclosed embodiments are not limited to such an attachment configuration. Other possible configurations include a cooperating threaded surface (see reference numeral 108 in FIG. 4) or any similar known attachments.

The first adapter cup 10 also includes a substantially cylindrical lower portion 26. The inner surface of the lower portion 26 defines a lower bore 28 that fluidly communicates with the upper bore 18. In this embodiment, the lower portion 26 has a threaded outer surface 30 with a diameter D₂. In a preferred embodiment, D₂ is approximately three inches for use with a conventional toilet tank with a three inch discharge hole. However, this specific diameter is not limitive.

Positioned axially between the rim 16 and lower portion 26 on the first adapter cup 10 of FIGS. 1A and 1B is an octagonal intermediate portion 32. As depicted in the Figures, the intermediate portion 32 projects radially beyond the respective outer surfaces, 20 and 22.

Depicted in FIGS. 2A and 2B is an embodiment of an additional adapter cup 40 that is included in the disclosed valve kit. The additional adapter cup 40 has a rim 42 that is substantially identical to the rim 16 of the first adapter cup 10. In this embodiment, the rim 42 has an inner surface 46 and an outer surface 50. The inner surface 46 defines a bore 44 with a diameter D₁. The rim 42 is configured for attachment to another valve assembly piece. Here, the inner surface 46 also has a slot adapted to achieve a bayonet fitting 48. Like the first adapter cup 10, the configuration for attachment to another valve assembly piece can depart from a bayonet fitting. However, the respective rims, 16 and 42, of the first and second adapter cups, 10 and 40, within a single kit will be substantially identical.

The additional adapter cup 40 has a substantially cylindrical lower portion 52 with an inner surface and a threaded outer surface 54. The threaded outer surface 54 has a diameter D₃. As shown in the Figures, the diameters D₂ and D₃ of the respective adapter cup lower portions, 26 and 52, are different. In this particular embodiment, D₃ is approximately two inches and is appropriate for use in a conventional toilet tank with a two inch discharge hole. The inner surface of the additional cup lower portion 52 defines a second lower bore 56 that is in fluid communication with the second upper bore 44.

Like the embodiment of the first adapter cup 10, positioned axially between the upper and lower portions, 42 and 52, of this additional adapter cup 40 embodiment is an octagonal intermediate portion 58. The additional cup intermediate portion 58 projects radially beyond the outer surfaces of the rim and lower portion, 42 and 52. The flush valve kit contains at least two adapter cups with different sized lower portions, such as those depicted in FIGS. 1A-1 B and 2A-2B.

FIGS. 3A-3C depict an embodiment of a main body valve fitting 60 that is included in the universal valve kit. This main body fitting 60 comprises a cylindrical wall 62 with an outer surface 64 and inner surface 66. The first end of the cylindrical wall defines an inlet 68 and the second end defines an outlet 70. A channel 72 spans from the inlet 68 to the outlet 70. As indicated in FIGS. 3A-3C, the plane defined by the inlet 68 is sloped from a high edge 74 to a low edge 76 in this embodiment.

In this embodiment, the outer surface 64 of the wall 62 has a bayonet fitting 78 positioned proximate the outlet end 70. The bayonet fitting 78 is configured for engagement with each of the first and second adapter cup bayonet fittings, 24 or 48. As noted in reference to the adapter cups, the bayonet fitting 78 on the main body fitting 60 is not a limiting attachment configuration. Other attachment configurations, such as threading (see FIGS. 4 and 5), snapping grooves or the like can be substituted as appropriate.

In this embodiment, an L-shaped passage 80 extends from a lateral opening 82 in the cylindrical wall 62 generally below the high edge 74 of the inlet 68. The upper end 84 of the L-shaped passage 80 is configured for engagement with an adjustable overflow tube 86 or like component. The L-shaped passage has an outer surface 88 that is configured for swingable attachment to a generally circular flapper 90. This embodiment features substantially identical projections 92 positioned on opposite lateral sides of the L-shaped passage 80. However, the configuration for attachment to a flapper is not limited in this way.

The flapper 90 may be included in the flush valve kit or may be a conventional commercially available flush valve flapper suitable for swingable attachment to the particular main body fitting. As can be seen in FIGS. 4 and 5, this flapper 90 has an arm 94 fit with notches 96 positioned to engage the opposite projections 92 on the L-shaped passage 80. Preferably, the outer radial edge 98 of the flapper extends radially beyond the cylindrical wall 62.

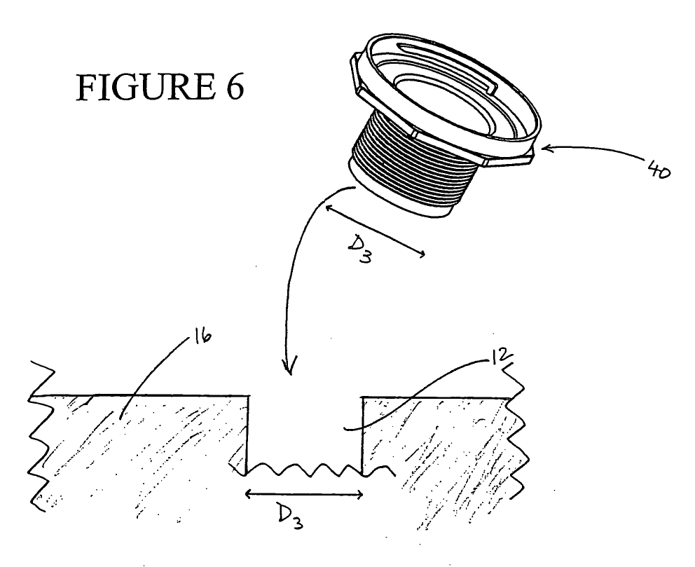

Typical flush tanks have discharge holes with diameters of either two or three inches. When installing the universal valve system into a flush tank, an installer first identifies the size of the discharge hole and chooses the corresponding adapter cup, 10 or 40, from the kit. For instance, if the tank has a two inch discharge hole, the second adapter cup (FIGS. 2A-2B) is chosen (similarly, the FIGS. 1A-1B adapter cup is appropriate for tanks with three inch discharge holes). As depicted in FIG. 6, the lower portion 52 is inserted relatively flushly into the similarly sized discharge hole 12. The o-ring or washer 100 positioned around the cup below the projecting intermediate portion 58 helps create a fluid tight seal between the adapter cup 40 and the discharge hole 12. The installer can apply a downward force on the intermediate portion 58 or use the intermediate portion to rotate the adapter cup to further tighten the seal.

Once the adapter cup 40 is positioned tightly within the discharge hole 12, the main body fitting 60 is attached. Because the respective rims, 16 and 42, of the first and second adapter cups are substantially identical, the same main body fitting and flapper can be employed in any flush tank, regardless of the size of its discharge hole. The adapter cup and main body fitting embodiments depicted in FIGS. 2A-2B and 3A-3C are attached via the cooperating bayonet fittings, 48 and 78. FIG. 5 shows the engagement of another embodiment of a main body fitting 102 and adapter cup 104. These embodiments employ cooperating threaded surfaces 108 and 110, rather than the bayonet fittings utilized in the prior embodiments. Another o-ring 112 is positioned around the cylindrical wall 62 to help achieve a fluid tight seal between the main body fitting 102 and the adapter cup 106. It is noteworthy that the relative inner and outer surface locations of the bayonet fittings and threaded surfaces depicted in the Figures are not limited as such—i.e., the outer surface of the cup rims can cooperate with the inner surface of the main body fitting lower portion.

In FIGS. 4 and 5, the chain 116 is shown in a relaxed position, with the flapper 90 abutting the inlet edge 114 of the respective main body fittings 102. The flapper 90 is generally made of a plastic or rubber material suitable for creating a fluid tight seal with the inlet edge 114 when in the closed position. The flapper 90 is swingable relative to the main body fitting 102 via application of a force F in the direction away from the main body fitting.

In common toilet tank configurations, the chain 116 depends from a flush rod that extends from a lever (not pictured). Opposite the flush rod, the chain 116 is attached to the flapper 90. When the lever is depressed, the rod pulls the chain 116 upwards and applies a force F on the flapper 90. It is noteworthy that the disclosed embodiments are not limited to the described lever-chain-flapper configuration. Other known means for applying a force on the flapper in the direction away from the inlet can be implemented.

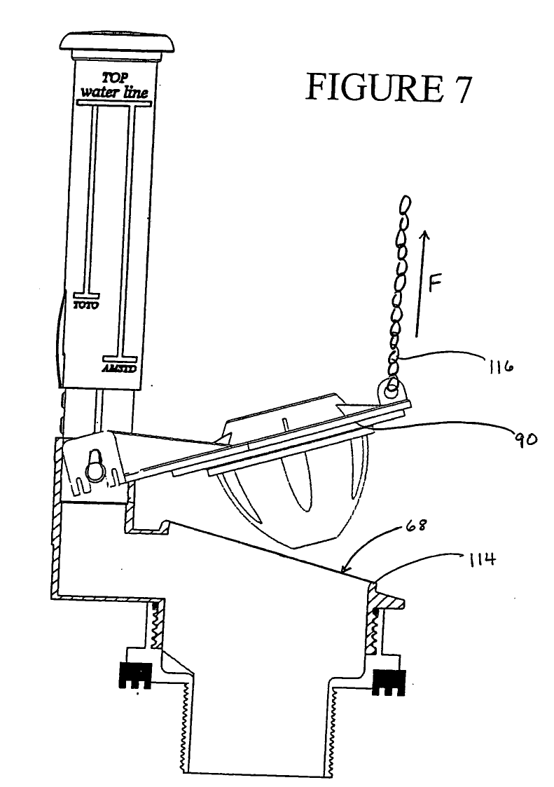

As depicted in FIG. 7, application of the force F swings the flapper 90 to a raised position away from the inlet edge 114, thus opening the inlet 114 and allowing fluid communication between the interior of the tank and the discharge hole 12. This fluid communication causes the water in the tank to discharge and the toilet to flush. As the tank empties, the flapper 90 returns to the closed position abutting the inlet edge 114 to reseal the valve system.

In another embodiment, additional adapter cups, similar to those depicted in FIGS. 1A-2B, can be made available separately outside of a kit. Thus, a worn adapter cup can be easily replaced without replacing the entire valve assembly.

In yet another embodiment, the kit also can include an overflow tube for incorporation into the valve assembly, as depicted in FIGS. 4, 5 and 7. Likewise, the kit can include a flapper similar to that depicted as Reference Numeral 90 in the drawings.

Not only do the disclosed embodiments provide a flush tank valve kit that allows a flush valve to be installed in tanks with discharge holes of varying sizes, but they enable increased flow to be achieved in tanks with smaller discharge holes. For example, installing the valve assembly of FIGS. 5 and 7 into a tank with a two inch discharge hole will result in increased flow due to the wider inlet 118. While the disclosed embodiments generally concentrate on conventional two and three inch discharge holes, embodiments are not limited to such sizes.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

1. A flush valve kit for use in a flush tank having a discharge hole, comprising:
(a) a first adapter cup with a rim and lower portion with an outer diameter D₁ configured for insertion into the discharge hole, the adapter cup defining a first through passage;
(b) at least one additional adapter cup with a rim that is substantially identical to the first adapter cup rim and a lower portion with an outer diameter D₂ that is smaller than D₁, the at least one additional adapter cup defining an additional through passage;
(c) a main body fitting with an inlet opposite an outlet, the main body fitting configured to cooperate with one of the substantially identical first or at least one additional cup rims to create a fluid tight connection therewith proximate the main body fitting outlet.

2. The flush valve kit of claim 1, further comprising a flapper configured to swingably attach to the main body fitting and swing between a closed position abutting the inlet, thereby creating a fluid tight seal therewith, and an open position raised from the inlet.

3. The flush valve kit of claim 1, wherein D₁ is about three inches and D₂ is about two inches.

4. The flush valve kit of claim 1, wherein each of the adapter cups has an axial length and further comprises a rigid projection positioned axially between the rims and lower portions, projecting radially beyond the outer surfaces of the respective upper and lower portions.

5. The flush valve kit of claim 4, wherein the rigid projection is octagonal.

6. The flush valve kit of claim 1, wherein the outer surfaces of each of the respective adapter cup lower portions is threaded.

7. The flush valve kit of claim 1, wherein the rim of each of the respective adapter cups has a slot adapted to achieve a bayonet fitting configured to cooperate with a bayonet fitting on the main body fitting to create a fluid tight attachment therewith.

8. The flush valve kit of claim 1, wherein the outer surface of the rim of each of the respective adapter cups is threaded, the threading being configured to cooperate with a threaded portion on the main body fitting to create a fluid tight attachment therewith.

9. The flush valve kit of claim 1, further comprising an o-ring positioned around the outer surface of the main body fitting configured to assist in creating a fluid tight seal between the main body fitting and one of the respective adapter cups.

10. The flush valve kit of claim 4, further comprising a washer positioned around the lower portion of each respective adapter cup abutting the rigid projection, configured to assist in creating a fluid tight seal between the respective adapter cup and the discharge hole.

11. A flush valve kit for use in a flush tank having a substantially cylindrical discharge hole, comprising:
(a) a first adapter cup with an axial length, having
a cylindrical rim with an inner surface and an outer surface, the inner surface defining an upper bore with a diameter D₁ and having a slot adapted to achieve a bayonet fitting,
a cylindrical lower portion with an inner surface and a threaded outer surface, the inner surface defining a lower bore in fluid communication with said upper bore, the lower portion having an outer diameter of approximately three inches, and
an octagonal intermediate portion positioned axially between said rim and said lower portion, projecting radially beyond the respective outer surfaces of the rim and the lower portion;
(b) an additional cup with an axial length, having
an additional cylindrical rim that is substantially identical to the first cylindrical rim,
an additional cylindrical lower portion with an inner surface and a threaded outer surface, the inner surface defining an additional lower bore in fluid communication with the additional upper bore, the lower portion having an outer diameter of approximately two inches, and
an octagonal intermediate portion positioned axially between said additional rim and said additional lower portion, projecting radially beyond the respective outer surfaces of the additional rim and additional lower portion;
(c) a main body fitting, having
a cylindrical wall with a lateral opening,
a first end defining an inlet with a sloped open face and a second end defining an outlet, a channel spanning from the inlet to the outlet,
an outer surface with a slot adapted to achieve a bayonet fitting proximate the outlet end, the main body bayonet fitting configured for cooperation with the bayonet fitting of the inner surface of any of the cup rims, and
an L-shaped passage having an outer surface, extending from the wall opening and in fluid communication with the channel, wherein
a generally circular flapper is configured to abut said cylindrical wall of the main body fitting at the inlet, the flapper having a projection configured for swingable attachment to the outer surface of said L-shaped passage, the outer radial edge of said flapper extending radially beyond said cylindrical wall of the main body fitting, one of the adapter cup lower cylindrical portions is inserted into the substantially cylindrical discharge hole of the toilet tank creating a fluid tight seal therewith, the main body fitting is engaged with the inserted adapter cup via the respective cooperating bayonet fittings, and said flapper is swingable relative to said L-shaped passage from a closed position abutting the cylindrical wall at the inlet to an open position raised from the inlet by application of a force F on said flapper in the direction away from said inlet, the abutment of said flapper and said cylindrical wall in the closed position fluidly sealing the tank from the outlet and said raised position allowing fluid communication between said tank and said outlet.

12. An adapter cup for use with and configured for fluid tight attachment to a separate piece of the valve assembly in a flush tank having a substantially cylindrical discharge hole, comprising
an upper substantially cylindrical rim having an outer surface and an inner surface defining a bore,
a lower substantially cylindrical portion defining a passage in fluid communication with the bore, the lower portion having an outer diameter D₂ that corresponds substantially to the diameter of the discharge hole, and being adapted for insertion into the substantially cylindrical discharge hole creating a fluid tight seal therewith.

13. The adapter cup of claim 12, wherein D₁ is between about two inches and about three inches.

14. The adapter cup of claim 12 having an axial length and further comprising a rigid projection positioned axially between the upper and lower portion projecting radially beyond the outer surfaces of the rim and lower portion.

15. The adapter cup of claim 12, wherein the outer surface of the lower portion is threaded.

16. The adapter cup of claim 12, wherein either of the outer or inner rim surfaces is threaded, said threaded surface configured to cooperate with a threaded surface on another separate piece of the valve assembly.

17. The adapter cup of claim 12, wherein either of the outer or inner rim surfaces has a slot adapted to achieve a bayonet fitting configured to cooperate with a bayonet fitting on another separate piece of the valve assembly.

18. The adapter cup of claim 12, wherein the cross sectional area of the upper bore is between about 1.5 and about 3.5 times the cross sectional area of the passage.

19. A method of installing a flush tank valve in a flush tank having a substantially cylindrical discharge hole, comprising:
(a) identifying the size of the discharge hole;
(b) choosing an adapter cup that has a cylindrical lower portion with an outer diameter that corresponds substantially to the diameter of said discharge hole from a kit that includes a plurality of adapter cups each having substantially identical upper rims and a cylindrical lower portion with a different diameter with respect to each other;
(c) inserting the cylindrical lower portion of the chosen adapter cup into the discharge hole, thereby creating a fluid tight seal therewith; and
(d) connecting a main body fitting to the rim of the chosen cup, the main body fitting and rim cooperating to create a fluid tight connection, the main body fitting having a cylindrical wall with a lateral opening, a channel spanning between a first end defining an inlet and a second end defining an outlet, and an L-shaped passage extending from the lateral opening in fluid communication with the channel;
(e) attaching a generally circular flapper configured to abut in a fluid tight seal with the cylindrical wall at the inlet when in a closed position to the main body fitting, the flapper being swingable relative to the L-shaped passage from the closed position to a raised open position via application of a force on the flapper in the direction away from the cup.

20. The method of claim 19, further comprising the step of removing an installed valve from the flush tank prior to step (a).
